(19) United States
(12) Patent Application Publication
(10) Pub. No.: US 2008/0176703 A1
(43) Pub. Date: Jul. 24, 2008

(54) Locking Differential Improvements

(75) Inventor: Raleigh Hoberg, Klemzig (AU)

Correspondence Address: BROOKS KUSHMAN P.C., 1000 TOWN CENTER, TWENTY-SECOND FLOOR, SOUTHFIELD, MI, 48075, US

(73) Assignee: 4WD EQUIPMENT SA PTY LTD, Gilles Plains, S.A. (AU)

(21) Appl. No.: 11/912,889

(22) PCT Filed: May 2, 2006
(86) PCT No.: PCT/AU2006/000566

§ 371 Date: Oct. 27, 2007

(30) Foreign Application Priority Data
May 5, 2005 (AU) 2005902268

(51) Int. Cl. F16H 48/28; F16H 48/20; F16D 1/06; F16D 11/14

(52) U.S. Cl. 475/235

(57) ABSTRACT

A differential locker having a clutch member (1) having a spring retaining aperture (2) for holding a spring (7) in collinear with a pin (3, 4) in a correspondingly positioned further clutch assembly. The spring access through the side (11, 12) of the clutch assembly is provided by a slot (10) passing fully through the side wall of the clutch assembly and extending from an inner face of the clutch member (1).

### TECHNICAL FIELD

This invention relates to locking differentials particularly of a type having annular friction hack clutch assemblies for normally connecting a drive shaft of a vehicle to a pair of axially aligned driven axle shafts.

### BACKGROUND OF THE INVENTION

The technical area to which this invention is directed is well set out in the various other technical specification such as U.S. Pat. No. 5,836,220 published in 1998, and U.S. Pat. No. 5,413,015 in the name of Zentmyer and U.S. Pat. No. 5,715,733 in the name of Dissett. In each of these cases there is disclosed a pair of clutch assemblies which are biased apart by a plurality of spring assemblies each including a locking pin collinearly arranged relative to one or more helical springs.

The problem to which this invention is directed can best be explained by reference to drawings in U.S. Pat. No. 5,715,733 where there is shown in FIGS. 14, 15 and 16, the way in which a spring is inserted through a spring access opening to 32 so as to act collinearly with the locking pin.

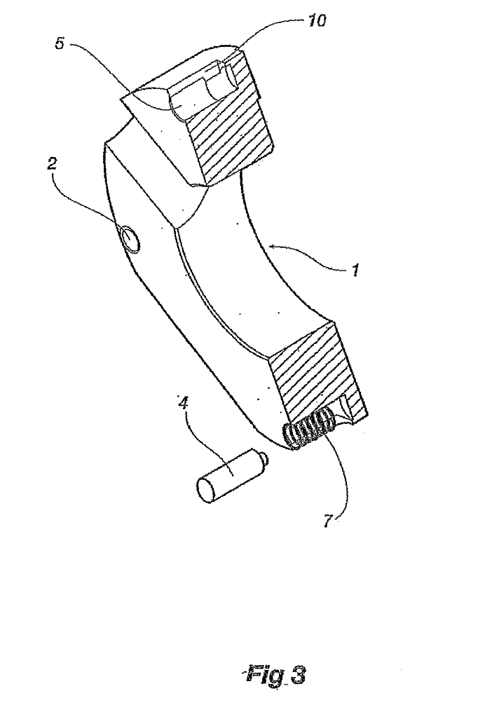

The problem relates to the manufacture of the unit that is shown in FIGS. 9, 10, 11, and 12 of that same U.S. Pat. No. 5,715,733

The cost of manufacture of such a product depends upon the difficulties associated with any manufacturing technique.

I have found that by making a change in the shape of the spring holding aperture, that this can then lead to significant savings in relation to manufacturing time and costs.

### BRIEF SUMMARY OF THE INVENTION

What I propose is that instead of having a spring access opening as is shown which is the form of a window passing through to an oversized bore, that the spring access opening be lengthened so that it is opened to the inner face.

This on its own however, would simply mean that a spring would not be able to be kept in position, so that accordingly, I provide means to positively locate the spring at the inner end, and provide an interlocking fit with the spring with respect to the retaining pin at the other end of the spring.

The advantage of this change arises because it allows the manufacture of the unit to be restricted to only use three axiis instead of as has been hitherto the case, four axiis.

As will be seen, if an end mill is directed into the face of the unit to cut the oversized spring retaining bore, it is then a simple matter to cause this to proceed also diametrically so as to cut through to the outer wall and through this leaving thereby this slot.

This therefore avoids to having to continue with a machining operation in which a tool has to then be orientated so as to be rotating about a diametrical direction and to effect the cutting of the elongate spring access opening.

As this is avoided, the part itself becomes much simpler to manufacture.

Further, however, a less complex machining process can be involved and in some instances, this can include therefore, more economically usable machines than might be the case if a fourth axis cut is required.

Yet a further advantage of the invention, is that it facilitates batch production, where a multitude of parts can be manufactured by a single machine without the need to re-orientate the parts.

The invention in one form could be said to reside in a differential locker having a clutch member having a spring retaining aperture for holding a spring in collinear alignment with a pin in a correspondingly positioned further clutch assembly characterized in that spring access through the side of the assembly unit is provided by a slot passing fully through the side wall of the unit and extending from an inner face.

In preference, the spring when retained in such a unit inter-engages with an end of a collinearly aligned pin.

In preference, the other end of the spring is held by being located within a bore within the spring retaining aperture.

In preference, the pair of assemblies have a plurality of pins and springs so aligned and there are symmetrically arranged bores on one side and spring retaining apertures in the other.

In preference, the spring in question is a helical spring and is retained with respect to the end of the collinearly aligned pin by the pin having a portion of narrower diameter such as to fit within the center core of the helical spring.

In preference, the spring retaining aperture includes a bore which is deeper than the opening to the side of the unit and which has a diameter at least as big as the diameter of the bottom of the spring so that this will seep thereby and be retained therein when in use.

A significant advantage of the arrangement described is also that it is a lot easier in assembly to insert a spring in this manner when in the confined space provided by a differential housed sufficiently to insert this type of unit.

For a better understanding of this invention it will now be described with the assistance of drawings where in

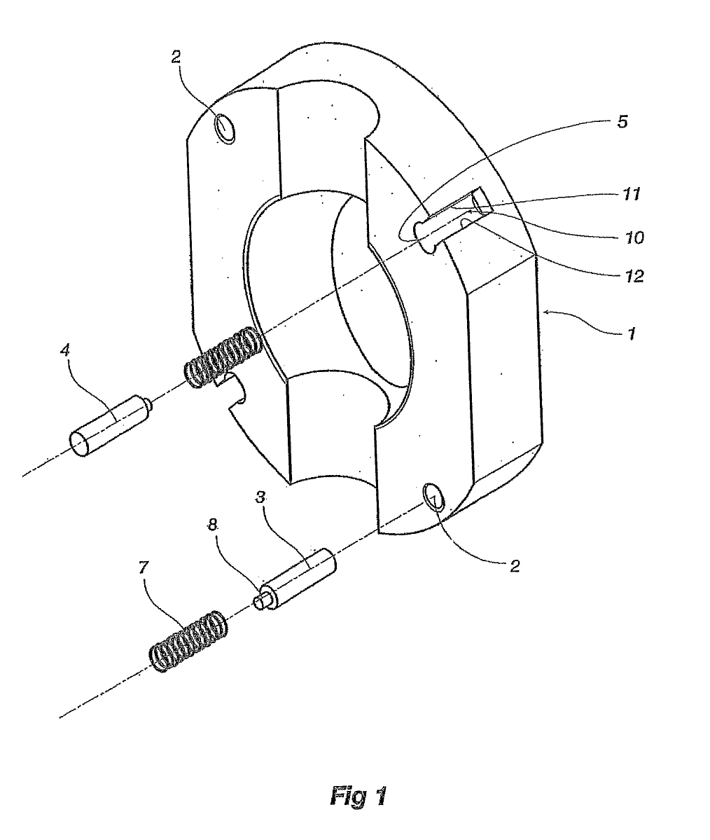

FIG. 1 is as s perspective view of a unit with associated springs and collinearly aligned pins,

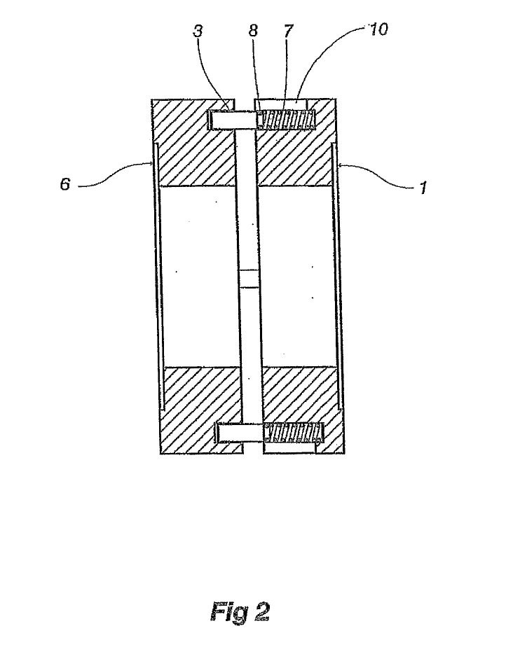

FIG. 2 is a cross sectional view showing the assembly of the two units with a c collinearly held pin partially engaging into the spring retaining aperture, and

FIG. 3 is a further perspective view and part cut away illustrating the way in which the pin is aligned with the spring retaining oversized aperture and how the pin sits within the bottom bore and interlocks with a bottom end of the collinear pin.

Referring in detail to the drawings, as will be seen we are describing one part of a clutch assembly the item being shown as 1 including a plurality of apertures 2 which are arranged to receive with relatively close fitting slideable retention, cylindrically shaped pins 3 and 4.

The shape of these spring retaining apertures is relatively complex in that they are intended to be able to be cut with a single cutting tool programmed to follow a particular path.

This path includes cutting an elongate deep bore with one part deeper than another part so as to provide a seat for a spring.

A further path for the tool is to proceed from a central position relative to the elongation of the oversized bore out through the wall so as to thereby cut a slot 10 with parallel sides 11, 12 and which has a width at least sufficient for a spring 7 to be passed there through.

The spring 7 is intended to be interlocked with an end 8 of the pin 9 which has a portion at the end of the lesser diameter than the main body of the pin and this is such that it will fit within the bore of the helical spring.

The assembly thereafter is of course enabled by the fact that with the pins in position, each spring can be inserted with a relative degree of freedom that such that the portion at the end of the pin shall be located into the bore of a respective helical spring and the bottom of this spring so as to extend and be seated and retained thereby in a deep bore portion.

As has been previously described, the advantage of this arrangement is two fold, one is that it is now much cheaper and more convenient to manufacture a unit having an aperture of this type and secondly, it facilitates the subsequent installation of a differential locker according to this design.

Throughout this specification the purpose has been to illustrate the invention and not to limit this.

1. A differential locker having a clutch member having a spring retaining aperture for holding a spring in collinear alignment with a pin in a correspondingly positioned further clutch assembly characterized in that spring access through the side of the assembly unit is provided by a slot passing fully through the side wall of the unit and extending from an inner face.

2. The differential locker of claim 1 where the spring when retained in such a unit inter-engages with an end of a collinearly aligned pin.

3. The differential locker of claim 2 where the other end of the spring is held by being located within a bore within the spring retaining aperture.

4. The differential locker of claim 1 where there is a pair of assemblies.

5. The differential locker of claim 4 where the pair of assemblies have a plurality of pins and springs so aligned and there are symmetrically arranged bores on one side and spring retaining apertures in the other.

6. The differential locker of claim 1 where the spring is a helical spring and is retained with respect to the end of the collinearly aligned pin by the pin having a portion of narrower diameter such as to fit within the center core of the helical spring.

7. The differential locker of claim 3 where the spring retaining aperture includes a bore which is deeper than the opening to the side of the unit and which has a diameter at least as big as the diameter of the bottom of the spring so that this will seep thereby and be retained therein when in use.
